(19) United States
(12) Patent Application Publication
(10) Pub. No.: US 2004/0150803 A1
(43) Pub. Date: Aug. 5, 2004

(54) Systems and methods for facilitating printing through interface exportation

(76) Inventor: John Leland Boldon, Emmett, ID (US)

Correspondence Address: HEWLETT-PACKARD COMPANY, Intellectual Property Administration, P.O. Box 272400, Fort Collins, CO, 80527-2400, US

(21) Appl. No.: 10/354,574

(22) Filed: Jan. 30, 2003

(51) Int. Cl. G03B 27/00

(52) U.S. Cl. 355/18

(57) ABSTRACT

Disclosed are systems and methods for facilitating printing through interface exportation. In one embodiment, a system and method pertain to exporting an imaging device-specific interface to a computing device, receiving printing selections entered by a user using the exported interface, and facilitating printing in accordance with the printing selections.

### BACKGROUND

With the advent of handheld computing devices such as personal digital assistants (PDAs), persons often now carry data along with them as they travel from place to place. Data stored on these devices may be printed by, for example, synchronizing the handheld device with the user's computer (e.g., personal computer (PC)), downloading the data to an appropriate program that executes on the computer, and then transmitting the data from the computer to an imaging device such as a printer.

When such an individual wishes to print a hardcopy, but is away from his or her computer, that individual may need to find a local imaging device to which the data stored on the handheld device may be directly transmitted, for instance using wireless communications. Unfortunately, there typically are hurdles to printing in such situations. In some cases, printing is not possible unless the source device (i.e., handheld device) comprises a driver that acts as a translator between the source application executing on the source device and the end device (i.e., imaging device). Although such a driver could be installed on the user's handheld device, the user typically must first locate an individual (e.g., information technology (IT) professional) that possesses the driver software or firmware. Where the user is at a foreign location, for instance a client's office, this may be difficult to achieve on short order. Moreover, even if this software/firmware can be located, the user may not wish to install it given that the storage capacity of the handheld device may be limited and the user may not ever need to print to that particular imaging device again.

Printing is sometimes feasible even if the user does not have the specific driver used with the target imaging device. For example, the handheld device may be configured to transmit data in a format that the imaging device is configured to recognize (e.g., American Standard Code for Information Interchange (ASCII) text). In such a case, printing may be possible, but the user typically will have little control over the printing outcome. In particular, the user may not be able to make selections that pertain to the specific capabilities of the imaging device such as font selection, simplex or duplex printing, and various finishing options. Accordingly, although a raw printout may be obtained, the user may not be able to utilize the full functionality of the imaging device.

In some situations, the capabilities of the imaging device may be accessed directly through an imaging device interface. For example, several higher-end imaging devices now include control panel displays that permit the user to enter commands directly into the imaging device. If such an imaging device is the target device, it may be possible for the user to make such selections via the device control panel. Even where this is possible, however, the user would need to enter commands and receive feedback from two different displays, one on the handheld device and one on the imaging device, all while making sure the communication link between the handheld device and the imaging device is not broken, which may be particularly difficult where line-of-sight communications (e.g., infrared (IR)) are used.

### SUMMARY

Disclosed are systems and methods for facilitating printing through interface exportation. In one embodiment, a system and method pertain to exporting an imaging device-specific interface to a computing device, receiving printing selections entered by a user using the exported interface, and facilitating printing in accordance with the printing selections.

In another embodiment, a system and method pertain to importing an imaging device-specific interface from an imaging device, receiving printing selections entered by a user using the imported interface, and facilitating printing in accordance with the printing selections.

### BRIEF DESCRIPTION OF THE DRAWINGS

The disclosed systems and methods can be better understood with reference to the following drawings. The components in the drawings are not necessarily to scale.

FIG. 1 is a schematic view of an embodiment of a system through which printing facilitated by interface by exportation may be obtained.

FIG. 2 is a block diagram of an embodiment of a handheld computing device shown in FIG. 1.

FIG. 3 is a block diagram of an embodiment of an imaging device shown in FIG. 1.

FIG. 4 is a flow diagram that illustrates an embodiment of operation of the system shown in FIG. 1 in providing printing facilitated by interface exportation.

FIGS. 5A and 5B provide a flow diagram that illustrates an embodiment of operation of an interface exportation manager of the imaging device shown in FIG. 3.

FIG. 6 is a flow diagram that illustrates an embodiment of operation of an interface importation manager of the handheld computing device shown in FIG. 2.

FIG. 7 is a front view of an example handheld computing device illustrating selection of a document for printing.

FIG. 8 is a front view of the handheld computing device of FIG. 7 illustrating display of an example screen of an imported interface that has been exported from an imaging device.

### DETAILED DESCRIPTION

As identified above, printing from a handheld computing device to a local imaging device can be problematic, particularly where the user wishes to access the full capabilities of the imaging device. As is described below, however, full utilization of a target imaging device can be obtained by exporting an interface from the imaging device to the user's handheld computing device. In such a case, the imaging device can harness the display of the handheld computing device to present various printing and/or document finishing options to the user for selection. With such operation, the user can be provided with greater control over the printing outcome without having to split his or her attention between two separate device interfaces.

In the following discussion, specific systems and methods are described. These systems and methods are mere embodiments, however, that are provided for purposes of example in explaining the manner in which printing may be facilitated through interface exportation. Accordingly, many alternatives are feasible. For instance, although “printing” is specifically discussed, other imaging device functionalities can be accessed through interface exportation including, for example, faxing and digital sending.

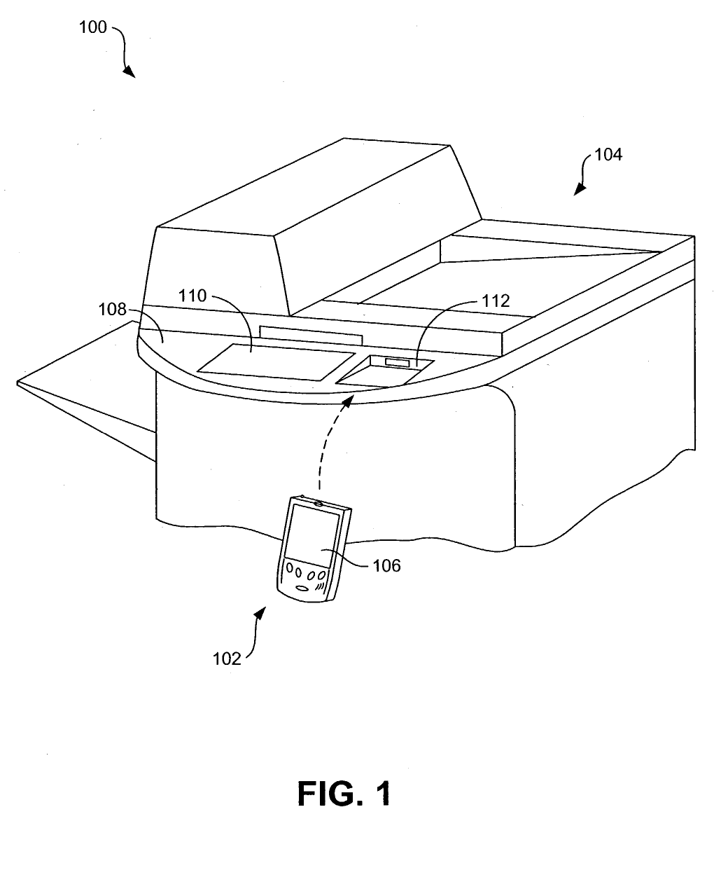

Referring now in more detail to the figures in which like numerals identify corresponding parts, FIG. 1 illustrates an example system 100 in which printing can be facilitated through interface exportation. As indicated in this figure, the system 100 generally comprises a handheld computing device 102 and an imaging device 104. As indicated in FIG. 1, the handheld computing device 102 can, for instance, comprise a personal digital assistant (PDA). Although a PDA is illustrated in the figure and specifically identified herein, other handheld computing devices could be used in the system 100. For example, the computing device could comprise a mobile telephone, a pager, a tablet computer, or the like. Moreover, although “handheld” computing devices are specifically discussed herein, the present disclosure is equally applicable to other portable computing devices including notebook computers.

As indicated in FIG. 1, the handheld computing device 102 comprises a display 106 with which information may be communicated to the user and, optionally, with which the user may enter commands with the device (e.g., in the case where the display is a touch-sensitive screen).

As illustrated in FIG. 1, the imaging device 104 may comprise a printer. More generally, however, the imaging device 104 comprises substantially any device that is capable of receiving data and generating a hardcopy output pertaining to the received data. Accordingly, the imaging device could alternatively comprise, a photocopier, a multifunction peripheral (MFP) device, an all-in-one device, a facsimile device, etc. The imaging device 104 includes a control panel 108 that, optionally, comprises a display 110. To facilitate communication between the handheld computing device 102 and the imaging device 104, the control panel 108 may further include a docking station 112 that provides a means for docking the handheld computing device on the imaging device such that communication components (e.g., wireless transceivers) of the two devices are maintained in alignment.

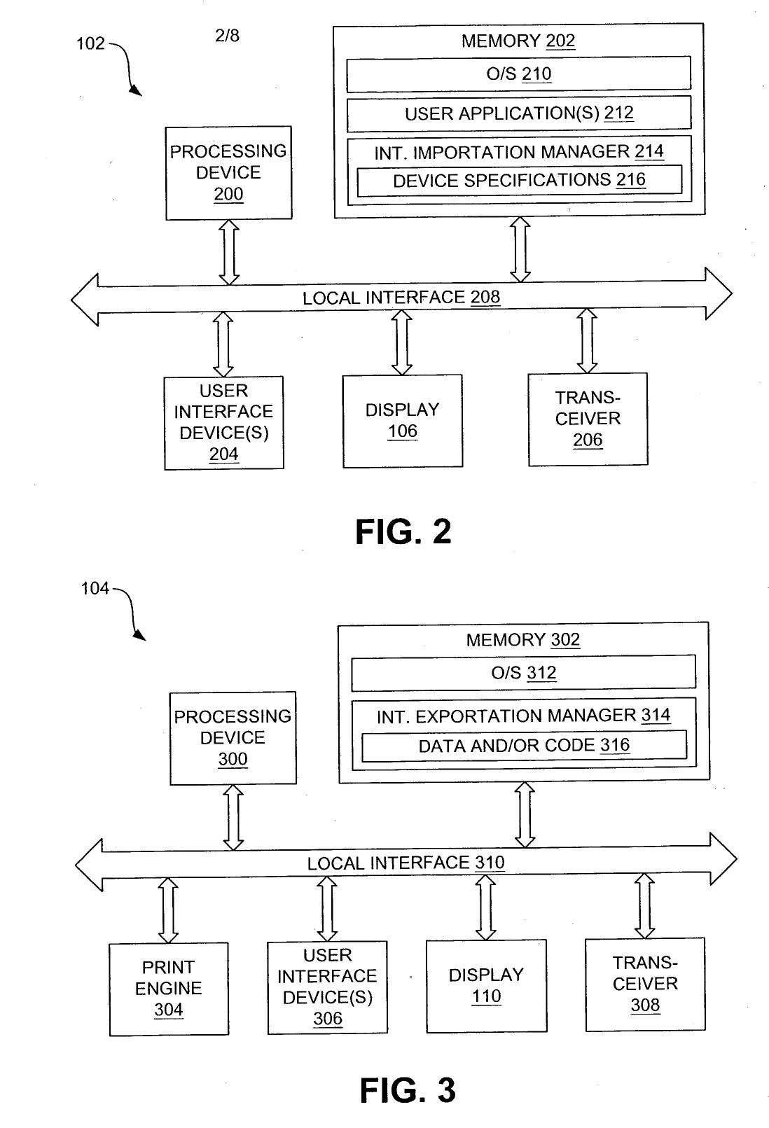

FIG. 2 is a block diagram illustrating an example architecture for the handheld computing device 102 shown in FIG. 1. As indicated in FIG. 2, the handheld computing device 102 comprises a processing device 200, memory 202, user interface devices 204, the display 106 (FIG. 1), and a transceiver 206, each of which is connected to a local interface 208. The processing device 200 can include any custom made or commercially available processor, a central processing unit (CPU) or an auxiliary processor among several processors associated with the handheld computing device 102, a semiconductor based microprocessor (in the form of a microchip), or a macroprocessor. The memory 202 can include any one or a combination of volatile memory elements (e.g., random access memory (RAM, such as DRAM, SRAM, etc.)) and nonvolatile memory elements (e.g., Flash, MRAM, ARS memory, etc.).

The user interface devices 204 comprise those components with which the user controls the handheld computing device 102. As depicted in FIG. 1, these interface devices 204 can include one or more buttons provided on the computing device 102. The display 106 typically comprises a liquid crystal display (LCD) and is used to present a graphical user interface (GUI) to the user. In cases in which the display 106 is touch-sensitive, the display may be considered to be a user interface device 204 in that commands may be entered by touching discrete portions of the display.

The transceiver 206 is used to enable communications back and forth between the handheld computing device 102 and the imaging device 104. The transceiver 206 is normally configured for wireless transmission (e.g., infrared (IR) or radio frequency (RF)) to avoid difficulties with physical incompatibilities between the handheld computing device 102 and the imaging device 104 that may arise due to distinct electrical connectors that may be provided on the devices.

The memory 202 normally comprises various programs (in software and/or firmware) including an operating system (O/S) 210, one or more user applications 212, and an interface importation manager 214. The O/S 210 controls the execution of other programs and provides scheduling, input-output control, file and data management, memory management, and communication control and related services. The user applications 212 comprise programs that may serve as source applications for print jobs. By way of example, these applications 212 comprise a word processing application, an email application, or the like.

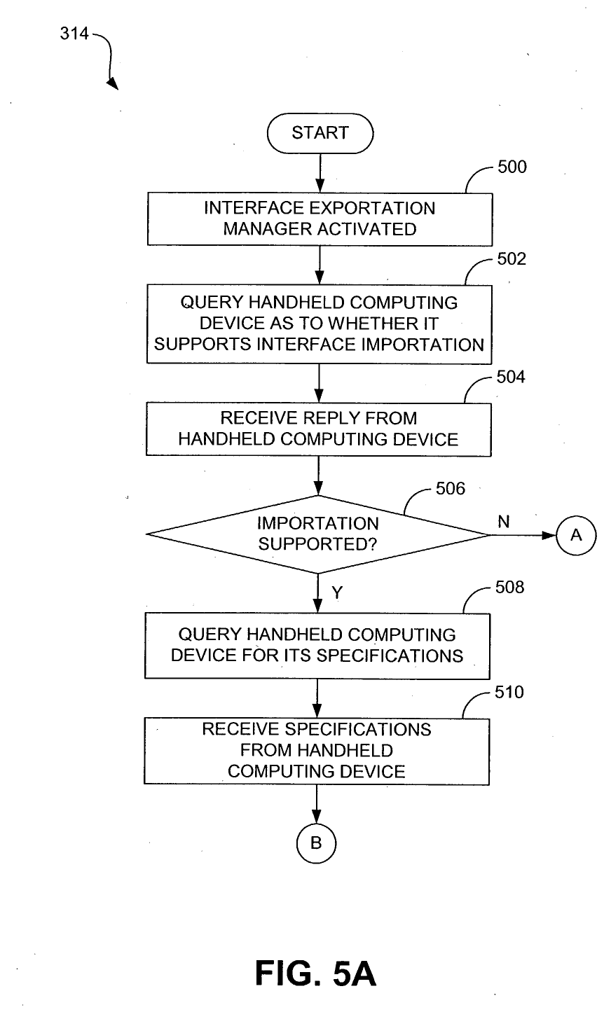

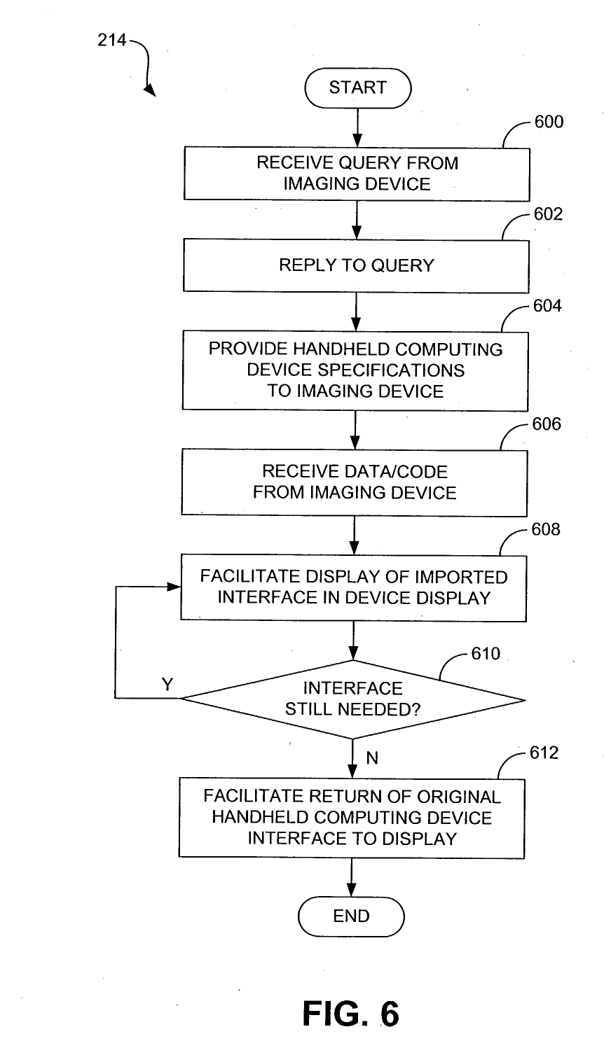

The interface importation manager 214 comprises a program that interacts with an interface exportation manager of the target imaging device. As is described below, the importation manager 214 is responsible for responding to requests made by the exportation manager and facilitating importation of an interface provided by the exportation manager. As indicated in FIG. 2, the importation manager 214 comprises, or has access to, device specifications 216 that may be provided to the exportation manager to facilitate its exportation of interface data and/or code to the handheld computing device 102. Operation of the importation manager 214 is discussed with reference to FIGS. 4 and 6.

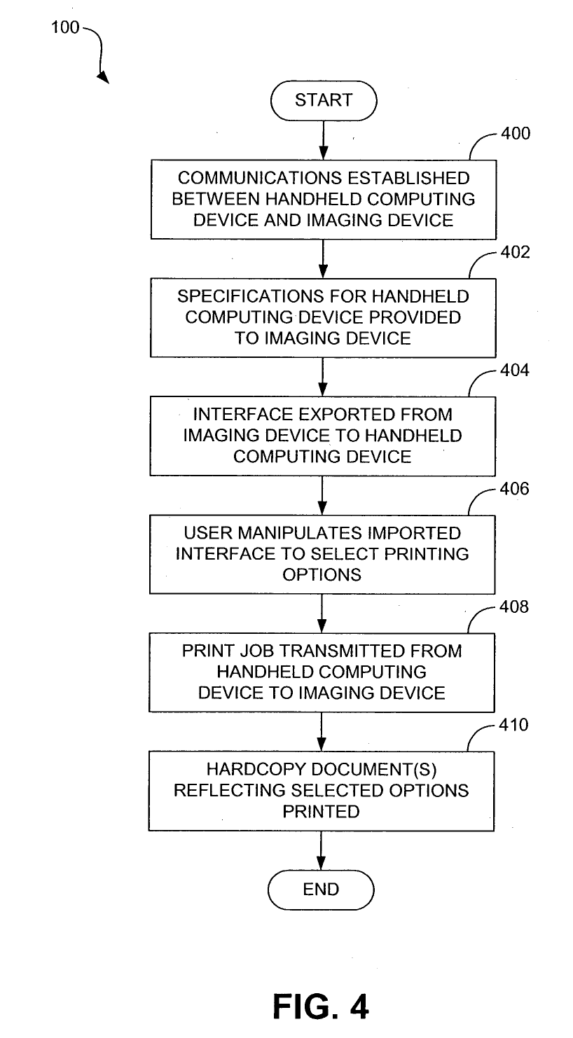

FIG. 3 is a block diagram illustrating an example architecture for the imaging device 104 shown in FIG. 1. As indicated in FIG. 3, the imaging device 104 comprises a processing device 300, memory 302, a print engine 304, user interface devices 306, the display 110 (FIG. 1), and a transceiver 308. Each of these components is connected to a local interface 310 that, by way of example, comprises one or more internal buses. The processing device 300 is adapted to execute commands stored in memory 302 and can comprise a general-purpose processor, a microprocessor, one or more application-specific integrated circuits (ASICs), a plurality of suitably configured digital logic gates, and other electrical configurations comprised of discrete elements both individually and in various combinations to coordinate the overall operation of the imaging device 104. The memory 302 can include any one or a combination of volatile memory elements (e.g., RAM) and nonvolatile memory elements (e.g., ROM, hard drive, etc.).

The print engine 304 comprises the components with which the imaging device 104 generates hardcopy documents. This engine 304 can comprise the common components of a laser-based imaging device, for instance, a paper drive mechanism, charging member, photosensitive member, optical scanning device, developing member, fusing system, etc. Alternatively, however, the engine 304 can comprise the components of an ink-based imaging device, for instance, a paper driver mechanism, an inkjet, etc.

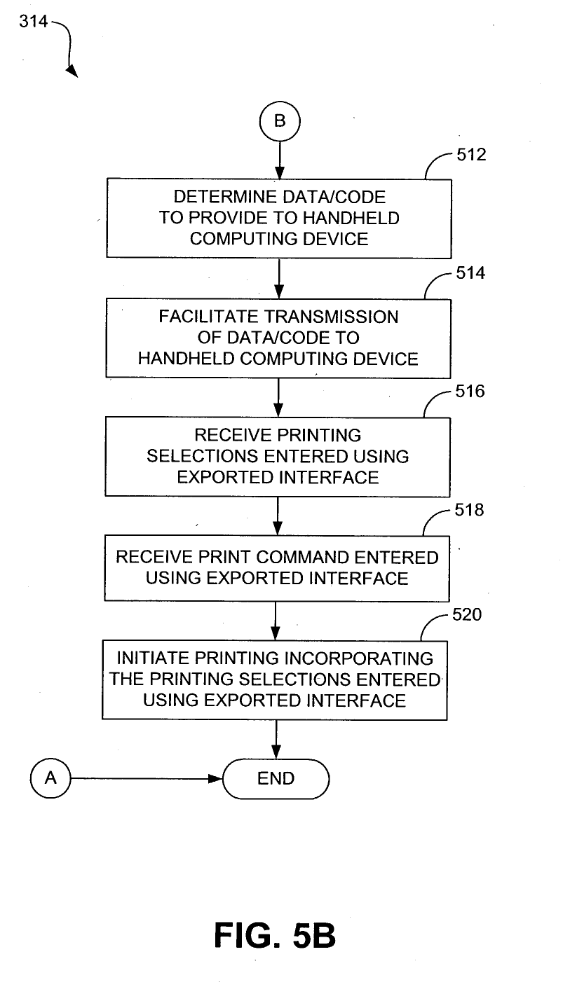

The user interface devices 306 comprise the interface tools with which the device settings can be changed and through which the user can communicate commands to the imaging device 104. By way of example, the user interface devices 306 comprise one or more keys and/or buttons with which the operation of the imaging device 106 can be controlled. The display 110 typically comprises an LCD and, like display 106 of the handheld computing device 102, may be considered a user interface device 306 if touch-sensitive. The memory 302 includes various programs (in software and/or firmware) including an O/S 312 that contains the various commands used to control the general operation of the imaging device 104. In addition, the memory 302 includes an interface exportation manager 314 that is used to export an interface to handheld computing devices that facilitates printing and selection of various imaging device options. The interface exportation manager 314 includes, or has access to, data and/or code 316 that facilitates the generation and support of an exported interface on the handheld computing device 102. Operation of the interface exportation manager 314 is discussed with respect to FIGS. 4 and 5.

Various programs have been described above. It is to be understood that these programs can be stored on any computer-readable medium for use by or in connection with any computer-related system or method. In the context of this document, a computer-readable medium is an electronic, magnetic, optical, or other physical device or means that can contain or store a computer program for use by or in connection with a computer-related system or method. The programs can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can store, communicate, propagate, or transport the program for use by or in connection with the instruction execution system, apparatus, or device.

The computer-readable medium can be, for example, an electronic, magnetic, optical, electromagnetic, infrared, or semiconductor system, apparatus, device, or propagation medium. More specific examples (a nonexhaustive list) of the computer-readable medium include an electrical connection having one or more wires, a portable computer diskette, a random access memory (RAM), a read-only memory (ROM), an erasable programmable read-only memory (EPROM, EEPROM, or Flash memory), an optical fiber, and a portable compact disc read-only memory (CDROM). Note that the computer-readable medium can even be paper or another suitable medium upon which a program is printed, as the program can be electronically captured, via for instance optical scanning of the paper or other medium, then compiled, interpreted or otherwise processed in a suitable manner if necessary, and then stored in a computer memory.

Example systems having been described above, system operation will now be discussed. In the discussions that follow, flow diagrams are provided. Any process steps or blocks in these flow diagrams may represent modules, segments, or portions of code that include one or more executable instructions for implementing specific logical functions or steps in the process. Although particular example process steps are described, alternative implementations are feasible. Moreover, steps may be executed out of order from that shown or discussed, including substantially concurrently or in reverse order, depending on the functionality involved.

As described above, printing from a handheld computing device to a local imaging device can be facilitated by exporting an interface from the imaging device to the user's handheld computing device. An example of such printing is described in FIG. 4. Beginning with block 400, communications are established between the handheld computing device 102 and the imaging device 104. As noted above, these communications typically comprise wireless communications using IR or RF transmission. In the latter case, various different protocols may be used including, for example, wireless application protocol (WAP), ultrawideband (UWB) protocol, 802.11 protocol from the Institute of Electrical and Electronics Engineers (IEEE), or Bluetooth™ protocol from Bluetooth SIG™, or another suitable protocol. As described above in relation to FIG. 1, such communications may be facilitated by placing the handheld computing device 102 in a docking station 112 provided on the control panel 108 of the imaging device 104. Although wireless communications are envisioned, direct communication through a physical wire or between mating electrical connectors is feasible where the devices are configured for such coupling.

Through the established communications, various specifications of the handheld computing device 102 can be provided to the imaging device 104, as indicated in block 402. These specifications generally pertain to those capabilities of the handheld computing device 102 that are relevant to hosting of an imported interface. By way of example, these specifications relate to the size of the computing device display 106, whether color images can be presented in the display, whether the computing device is capable of executing an executable program (e.g., Applet) designed to support the interface, etc. By providing this information to the imaging device 104, the imaging device need not maintain an up-to-date database of the specifications of each handheld computing device that may print to the imaging device.

Once the specifications have been received, an appropriate interface can be exported from the imaging device 104 to the handheld computing device 102 for presentation in the computing device display 106, as indicated in block 404. As is discussed in greater detail below, this exportation may involve the transmission of data that represents features to be presented in the display 106, as well as any supporting code that is required to register selection of the features and facilitate transmission of these selections. In some cases, exportation may involve the transmission of one or more executable programs to the handheld computing device 102 that are configured to generate the interface on the computing device display 106 and facilitate identification and communication of any user selections entered by the user with the interface. In any case, the interface typically includes data pertinent to selections that relate to imaging device functionalities that may otherwise not be accessible to the user if the interface had not been imported. Preferably, the interface has a layout similar to the interfaces typically presented on the handheld computing device 102 so as to have a familiar look and feel to the user.

Once the interface has been exported from the imaging device 104, and imported to the handheld computing device 102, the user may manipulate features of the interface, for example using a stylus, to select the various printing options that he or she desires, as indicated in block 406. For example, the user may tap onscreen “buttons” to select the number of copies, whether duplex printing is to be used, whether scaling is to be used, etc. After all desired selections have been made, a print job is transmitted from the handheld computing device 102 to the imaging device 104, as indicated in block 408. At this point, one or more hardcopy documents that reflect the user's selections are printed, as indicated in block 410.

FIGS. 5A and 5B provide an example of operation of the interface exportation manager 314 of the imaging device 104. Beginning with block 500 of FIG. 5A, the interface exportation manager 314 is activated. This activation typically occurs automatically upon the establishment of a communication link between the imaging device 104 and a handheld computing device 102. Again, the docking station 112 of the imaging device 104 may facilitate the establishing and maintaining of this link. Once activated, the exportation manager 314 queries the handheld computing device 102 as to whether it supports interface importation, as indicated in block 502, in particular, the exportation manager 314 queries the computing device as to whether it can follow a protocol in which the interface normally presented on the computing device display 106 can be replaced with an interface that pertains to the imaging device 104 such that the computing device display is used as a proxy display by the imaging device.

After the query has been sent, a reply is received, as indicated in block 504. From this reply, it can be determined, in decision block 506, whether interface importation is or is not supported. If not, exportation of the interface is not feasible and flow for the session is terminated (FIG. 5B). If, on the other hand, interface importation is supported by the handheld computing device 102, flow continues to block 508 at which the exportation manager 314 queries the handheld computing device for its specifications. As noted above with reference to FIG. 4, these specifications generally pertain to those capabilities of the handheld computing device 102 that affect the manner in which the imported interface can be hosted and may specifically pertain to the size of the computing device display 106, whether color images can be presented in the display, whether the computing device is capable of executing a received executable program, etc.

After these specifications are received, as indicated in block 510, flow continues to block 512 of FIG. 5B at which the interface exportation manager 314 determines what to send to the handheld computing device 102 to enable it to support the interface. In particular, the exportation manager 314 determines what data and/or code to provide to the handheld computing device 102 to facilitate its support of the interface. In terms of data, transmitted may be descriptions of the various features (e.g., buttons) to be presented (including text, graphics, and images), their placement within the computing device display 106, and the colors of the various features (where color is supported by the computing device).

Code that supports these features may include any code necessary to recognize selection of a feature (e.g., button) and register it so that it is communicated back to the imaging device 104. In one arrangement, this code is configured to facilitate immediate communication of the selection back to the imaging device 104. In another arrangement, all various selections may be noted and retained so that all selections are transmitted to the imaging device 104 at substantially the same time (e.g., when a “print” command is selected). By way of example, this functionality can be provided by an executable program (e.g., Applet) sent to the handheld computing device 102 that is configured to generate the interface and monitor its use. Although such code may be provided to the handheld computing device 102, such code may, alternatively, already exist on the computing device. In such a case, transmission of data alone to the handheld computing device 102 may be sufficient.

Next, with reference to block 514, the exportation manager 314 facilitates transmission of the data/code to the handheld computing device 102. Once any user selections have been entered by the user using the interface provided in the computing device display 106, the exportation manager 314 can then receive the printing selections, as indicated in block 516, as well as a print command likewise entered using the imported interface, as indicated in block 518. At this point, the exportation manager 314 can initiate printing of one or more hardcopy documents incorporating the various printing selections entered by the user via the imported interface, as indicated in block 520. Notably, feedback can be provided to the user via the imported interface of the handheld computing device 102 during printing. For instance, the user can be notified of the printing process with a “printing ______ of 20 pages” message. The data for such a message can be transmitted to the handheld computing device 102 from the imaging device 104 during printing.

FIG. 6 illustrates an example of operation of the interface importation manager 214 of the handheld computing device 102. Beginning with block 600, the importation manager 214 may be activated upon receiving a query from the imaging device 104 and, more particularly, from the interface exportation manager 314 of the imaging device. As noted above, this query may pertain to whether the handheld computing device 102 supports interface importation. In addition, the query may pertain to the specifications of the handheld computing device. Once the query or queries are received, the importation manager 214 replies, as indicated in block 602. This reply may comprise providing the handheld computing device specifications to the imaging device 104, as indicated in block 604.

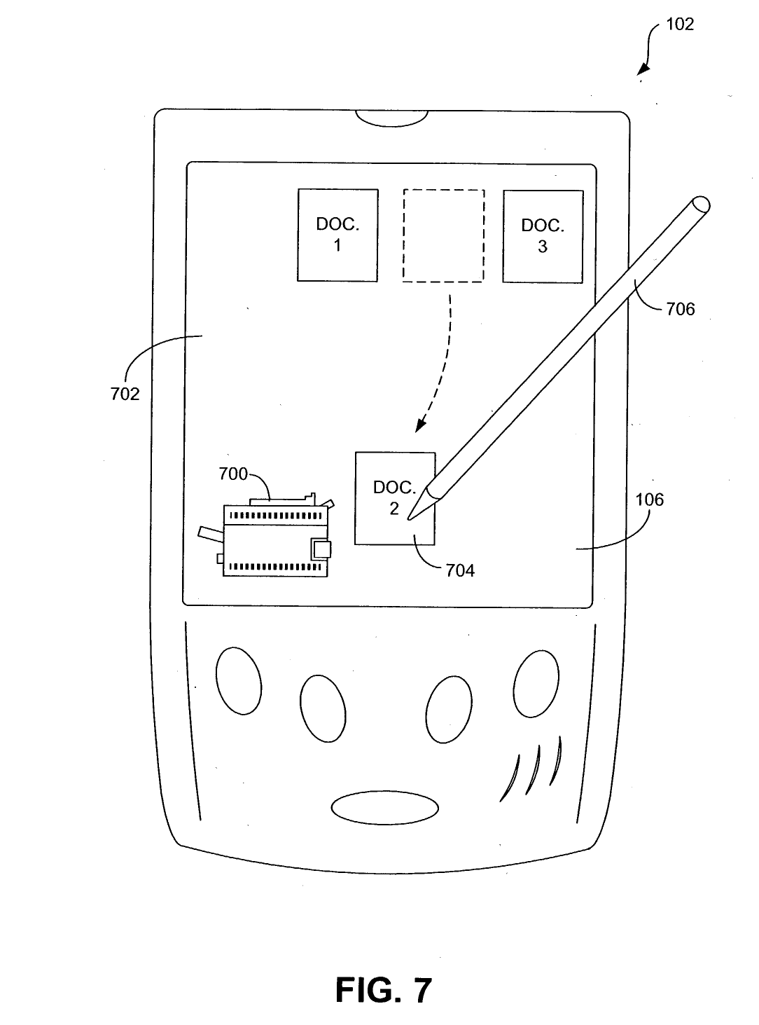

Next, the data and/or code necessary to generate and support the interface on the handheld computing device 102 is received, as indicated in block 606. At this point, the importation manager 214 has the information and/or code it needs to facilitate presentation of an imaging device-specific interface to the user. This interface can be presented immediately in the computing device display 106, or can be presented after the user has identified a document to be printed. In the latter case, the user can select a document for printing using, for example, a drag-and-drop procedure. An example of such a procedure is depicted in FIG. 7. As indicated in this figure, an imaging device icon 700 can be presented on a desktop 702 of the display 106 to communicate to the user that the imaging device and the handheld computing device have established a communication link and are ready for printing. The user can select a document icon 704 also provided on the desktop 702 that represents a document that the user wishes to print. To identify that the document is to be printed, the user can “drag” the document icon 704 over to the imaging device icon 700 using a stylus 706 so that the document icon can be “dropped” on the imaging device icon. In so doing, the user communicates a desire to generate a hardcopy document with the imaging device 104.

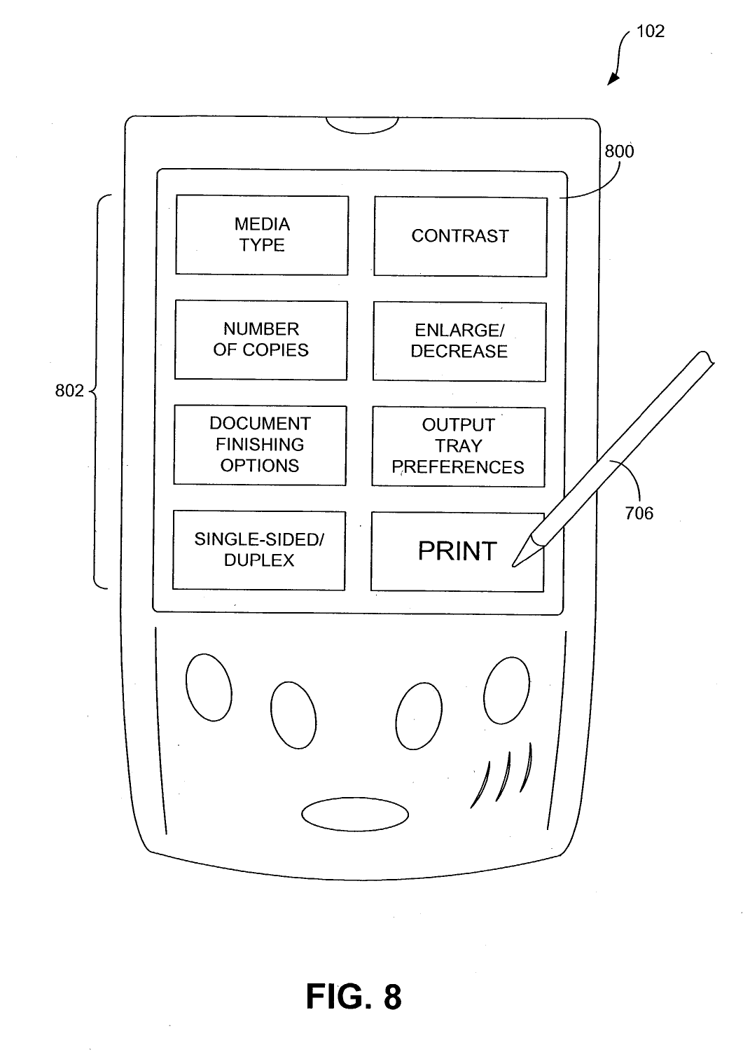

Returning to FIG. 6, after identifying the document that is to be printed, or upon receiving all data and/or code needed to generate the interface, the importation manager 214 facilitates display of the imported interface, as indicated in block 608. As noted previously, this interface is specific to the imaging device 104 and therefore provides access to particular functionalities that the imaging device possesses. An example screen of such an interface is depicted in FIG. 8. As shown in this figure, the imported interface screen 800 comprises a plurality of features in the form of selectable, on-screen “buttons” 802. As indicated in the example of FIG. 8, the particular interface screen 800 includes buttons 802 associated with selecting the media type, the number of copies to be created, document finishing options, single-sided or duplex printing, contrast, scaling, and output tray preferences. Although these particular options or functionalities have been identified, it is to be understood that they are merely exemplary in nature. Each button 802 may be associated with one or more other interface screens (not shown) such that a drill-down menu is provided. For example, the “document finishing options” button may be associated with an interface screen that pertains to folding and stapling options. By selecting this button (e.g., by tapping on it with the stylus 706), this other screen may be accessed.

With reference back to FIG. 6, it is determined in decision block 610 whether the imported interface is still needed. In other words, it is determined whether the printing session is done. Termination of the printing session can be indicated by the user by, for instance, selecting a “disconnect” button provided in one of the interface screens (not shown), or by simply breaking the communication link that had been established between the imaging device 104 and the handheld computing device 102. In either case, flow continues to block 612 at which the interface importation manager 214 facilitates the return of the original computing device interface to the device display 106. This may comprise marking all data and/or code received from the imaging device 104 for deletion. Alternatively, however, the data/code may be stored for later use in memory 202, if desired.

What is claimed is:

1. Method for facilitating printing, comprising:
exporting an imaging device-specific interface to a computing device;
receiving printing selections entered by a user using the exported interface; and
facilitating printing in accordance with the printing selections.

2. The method of claim 1, wherein the computing device is a handheld computing device; and wherein exporting an imaging device-specific interface comprises exporting an imaging device-specific interface to the handheld computing device with which a communication link has been established.

3. The method of claim 1, wherein exporting an imaging device-specific interface comprises facilitating transmission to the computing device of data pertinent to generating the interface on a display of the computing device.

4. The method of claim 1, wherein exporting an imaging device-specific interface comprises facilitating transmission to the computing device of code used to recognize selection of a feature presented in the interface.

5. The method of claim 4, wherein facilitating transmission of code comprises facilitating transmission of an executable program to the computing device.

6. The method of claim 1, wherein receiving printing selections comprises receiving selections entered with the exported interface and transmitted by the computing device.

7. The method of claim 1, further comprising detecting establishment of a communication link with the computing device.

8. The method of claim 1, further comprising receiving specifications regarding the computing device prior to exporting an imaging device-specific interface, and determining what data or code to be transmitted to the computing device in view of the received specifications.

9. A method for facilitating printing, comprising:
importing an imaging device-specific interface from an imaging device;
receiving printing selections entered by a user using the imported interface; and
facilitating printing in accordance with the printing selections.

10. The method of claim 9, wherein importing an imaging device-specific interface comprises receiving from the imaging device data pertinent to generating the interface on a display.

11. The method of claim 9, wherein importing an imaging device-specific interface comprises receiving from the imaging device code used to recognize selection of a feature presented in the interface.

12. The method of claim 11, wherein receiving code comprises receiving an executable program from the imaging device.

13. The method of claim 9, wherein facilitating printing comprises facilitating transmission of the received selections to the imaging device.

14. The method of claim 9, further comprising facilitating transmission of specifications regarding a computing device to receive the interface prior to importing an imaging device-specific interface.

15. An interface exportation manager stored on a computer-readable medium, comprising:
logic configured to facilitate transmission of an imaging device-specific interface to a handheld computing device so that the interface can be displayed in a display of the computing device;
logic configured to receive printing selections entered by a user using the interface; and
logic configured to facilitate printing in accordance with the printing selections.

16. The manager of claim 15, wherein the logic configured to facilitate transmission of an imaging device-specific interface is configured to facilitate transmission of data pertinent to generating the interface on the computing device display.

17. The manager of claim 15, wherein the logic configured to facilitate transmission of an imaging device-specific interface is configured to facilitate transmission of code configured to recognize selection of a feature presented in the imported interface.

18. The manager of claim 17, wherein the code comprises an executable program.

19. The manager of claim 15, further comprising logic configured to receive specifications regarding the computing device and to determine what data or code to be transmitted to the computing device in view of the received specifications.

20. An interface exportation manager, comprising:
means for transmitting an imaging device-specific interface to a handheld computing device;
means for receiving printing selections entered by a user using the imported interface; and
means for printing a hardcopy document in accordance with the entered printing selections.

21. An interface importation manager stored on a computer-readable medium, comprising:
logic configured to receive an imaging device-specific interface from an imaging device;
logic configured to recognize selections of printing options entered by a user using the interface; and
logic configured to facilitate printing in accordance with the printing selections.

22. The manager of claim 21, wherein the logic configured to receive an imaging device-specific interface comprises logic configured to receive and implement data pertinent to generating the interface on a display.

23. The manager of claim 21, wherein the logic configured to receive an imaging device-specific interface comprises logic configured to receive and implement code used to recognize selection of a feature presented in the interface.

24. The manager of claim 21, wherein the logic configured to facilitate printing comprises logic configured to facilitate transmission of the received selections to the imaging device.

25. The manager of claim 21, further comprising logic configured to facilitate transmission of specifications regarding a computing device to receive the interface.

26. An interface importation manager, comprising:
means for receiving an imaging device-specific interface from an imaging device;
means for recognizing selections of printing options entered by a user using the interface; and
means for transmitting the recognized selections to the imaging device.

27. An imaging device, comprising:
a processing device;
a print engine; and
memory including an interface exportation manager, the manager being configured to facilitate transmission of an imaging device-specific interface to a computing device, to receive printing selections entered by a user using the interface, and to facilitate printing in accordance with the printing selections.

28. A handheld computing device, comprising:
a processing device;
a display; and
memory including an interface importation manager, the manager being configured to receive an imaging device-specific interface from an imaging device that is configured for presentation in the display, to recognize selections of printing options entered by a user using the interface, and to facilitate printing in accordance with the printing selections.
